(19) United States
(12) Patent Application Publication
(10) Pub. No.: US 2026/0219921 A1
(43) Pub. Date: Jul. 30, 2026

(54) SYSTEMS AND METHODS FOR ARTIFICIAL INTELLIGENCE DISTRIBUTED AGENT ECOSYSTEM RESOURCE OPTIMIZATION

(71) Applicant: Dell Products L.P., Round Rock, TX (US)

(72) Inventors: Tyler R. COX, Austin, TX (US); Marc R. HAMMONS, Round Rock, TX (US); Jarrett SIMERSON, Northbrook, IL (US)

(73) Assignee: Dell Products L.P., Round Rock, TX (US)

(21) Appl. No.: 19/041,192

(22) Filed: Jan. 30, 2025

(51) Int. Cl. G06F 9/48

(52) U.S. Cl. CPC G06F 9/4818

(57) ABSTRACT

An information handling system may include a memory and a processor communicatively coupled to the memory, and configured to execute an agent system configured to collect and aggregate performance metrics from one or more artificial intelligence agents executing on one or more host systems and estimate parameters including resource requirements, performance targets, operating costs, and power usage associated with executing the one or more artificial intelligence agents on the one or more host systems.

### TECHNICAL FIELD

The present disclosure relates in general to information handling systems, and more particularly to methods and systems to optimize resources in an artificial intelligence distributed agent ecosystem.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

In an environment where user productivity is achieved through collaboration with and direction of a changing set of artificial intelligence agent entities operating as a team, many fundamental technology experiences and delivery patterns may be disrupted. Among them is a class of problems focused on the availability of and access to agent instances and knowledge stores by many users in varying intervals.

By providing access to information and intelligence through the composition of various technologies such as artificial intelligence models (including large language models), application programming interfaces, and user input interfaces, as specialized entities referred to as agents, and allowing those agents to cooperate with or without direct user guidance, additional system complexity and subsequent optimization techniques may become necessary. Additionally, constraints of agent hosting to specialized or semi-specialized compute requirements introduces additional management and optimization complexities. Finally, many of these agents may come with their own varied cost, subscription, and consumption models that have financial impacts that must be considered.

In a multi-user, multi-agent enterprise environment, connections between and usage of various combinations of users and agents into sessions may become a key workflow model. With a heterogeneous, potentially complex (multi-nodal/technology) agent hosting architecture across an enterprise information technology environment, tradeoffs between user availability, latency, information access, generative quality and quantity, and model complexity must be made, driven by user and enterprise key performance indicators.

### SUMMARY

In accordance with the teachings of the present disclosure, the disadvantages and problems associated with existing approaches to execution of artificial intelligence workloads in a distributed agent ecosystem may be reduced or eliminated.

In accordance with embodiments of the present disclosure, an information handling system may include a memory and a processor communicatively coupled to the memory, and configured to execute an agent system configured to collect and aggregate performance metrics from one or more artificial intelligence agents executing on one or more host systems and estimate parameters including resource requirements, performance targets, operating costs, and power usage associated with executing the one or more artificial intelligence agents on the one or more host systems.

In accordance with these and other embodiments of the present disclosure, a method may include collecting and aggregating performance metrics from one or more artificial intelligence agents executing on one or more host systems and estimating parameters including resource requirements, performance targets, operating costs, and power usage associated with executing the one or more artificial intelligence agents on the one or more host systems.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to collect and aggregate performance metrics from one or more artificial intelligence agents executing on one or more host systems and estimate parameters including resource requirements, performance targets, operating costs, and power usage associated with executing the one or more artificial intelligence agents on the one or more host systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure;

FIG. 2 illustrates a block diagram of a system for artificial intelligence distributed agent ecosystem resource optimization, in accordance with embodiments of the present disclosure; and

FIGS. 3A and 3B, (which may be collectively referred to herein as FIG. 3), illustrate a flow chart of an example method for artificial intelligence distributed agent ecosystem resource optimization, in accordance with embodiments of the present disclosure.

### DETAILED DESCRIPTION

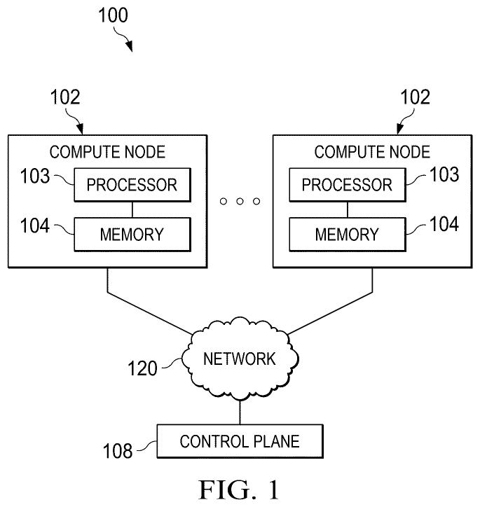

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may implement systems and methods for artificial intelligence distributed agent ecosystem resource optimization, as described in greater detail below. In particular, control plane 108 may implement an agent hosting optimization model and scoring system for a distributed, muti-agent enterprise hosting model.

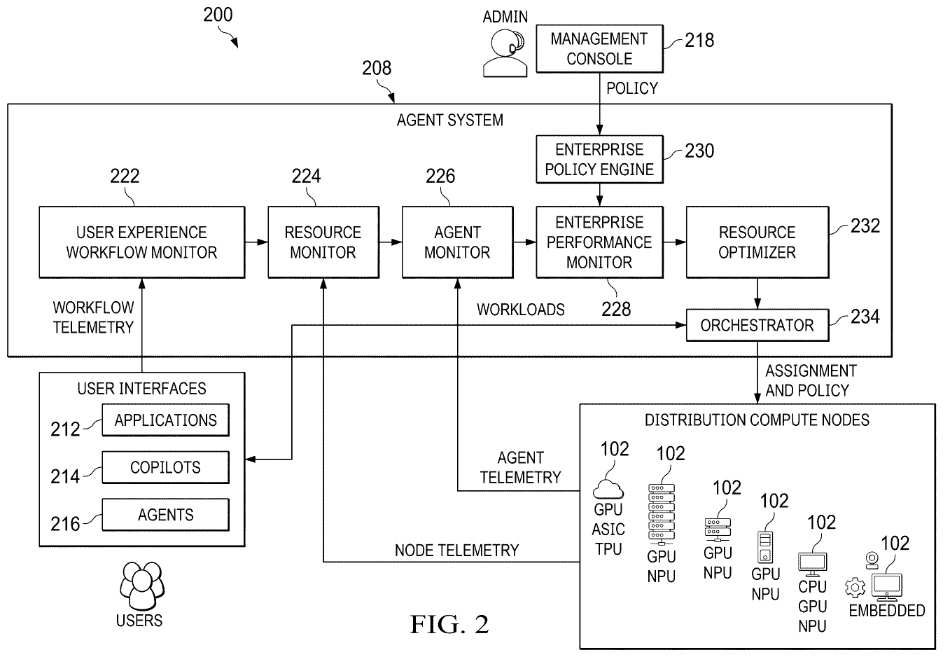

FIG. 2 illustrates a block diagram of a system architecture 200 for artificial intelligence distributed agent ecosystem resource optimization, in accordance with embodiments of the present disclosure. In some embodiments, system architecture 200 may be implemented using one or more components of system 100 described above.

As shown in FIG. 2, system architecture 200 may include a plurality of distributed compute nodes 102, an agent system 208, and a plurality of user interfaces that may include one or more applications 212, one or more artificial intelligence copilots 214, and one or more artificial intelligence agents 216.

Agent system 208 may be implemented in whole or part by control plane 108. As shown in FIG. 2, agent system 208 may include a user experience workflow monitor 222, a resource monitor 224, an agent monitor 226, an enterprise performance monitor 228, an enterprise policy engine 230, a resource optimizer 232, and an orchestrator 234.

User experience workflow monitor 222 may comprise any system, device, or apparatus configured to provide workflow telemetry associated with users, including assessment of productivity impact from hosting key performance indicators (e.g., as latency, quality, and quantity) and user metadata (activity classification, time to meeting, deadline, flow state).

Resource monitor 224 may comprise any system, device, or apparatus configured to provide node telemetry for compute nodes 102 and provide visibility to and workload management of all agent hosting and delivery services across an enterprise comprising system 100.

Agent monitor 226 may comprise any system, device, or apparatus configured to provide agent telemetry, including without limitation agent consumption, usage, and model metrics.

Enterprise performance monitor 228 may comprise any system, device, or apparatus configured to provide administrative telemetry and constraints, including without limitation fiscal constraints, quality-of-service requirements, and key performance indicator targets. Such constraints may be received from enterprise policy engine 230, and may be based on a policy implemented by an administrator at a management console 218.

Resource optimizer 232 may comprise any system, device, or apparatus configured to aggregate data and/or metadata from user experience workflow monitor 222, resource monitor 224, agent monitor 226, enterprise performance monitor 228, and enterprise policy engine 230, and based on such data and/or metadata, score, rank, prioritize, and produce per-artificial intelligence model session updates to system resources.

Orchestrator 234 may comprise any system, device, or apparatus configured to, based on capabilities of compute nodes 102, workload telemetry for compute nodes 102, and current loads upon compute nodes 102, and the scoring, ranking, and prioritization by resource optimizer 232, distribute artificial intelligence workloads across compute nodes 102 for execution of such workloads. In some embodiments, orchestrator 234 may comprise a workload orchestrator similar or identical that that described in U.S. patent application Ser. No. 19/037,553, filed Jan. 27, 2025, which is incorporated by reference herein in its entirety.

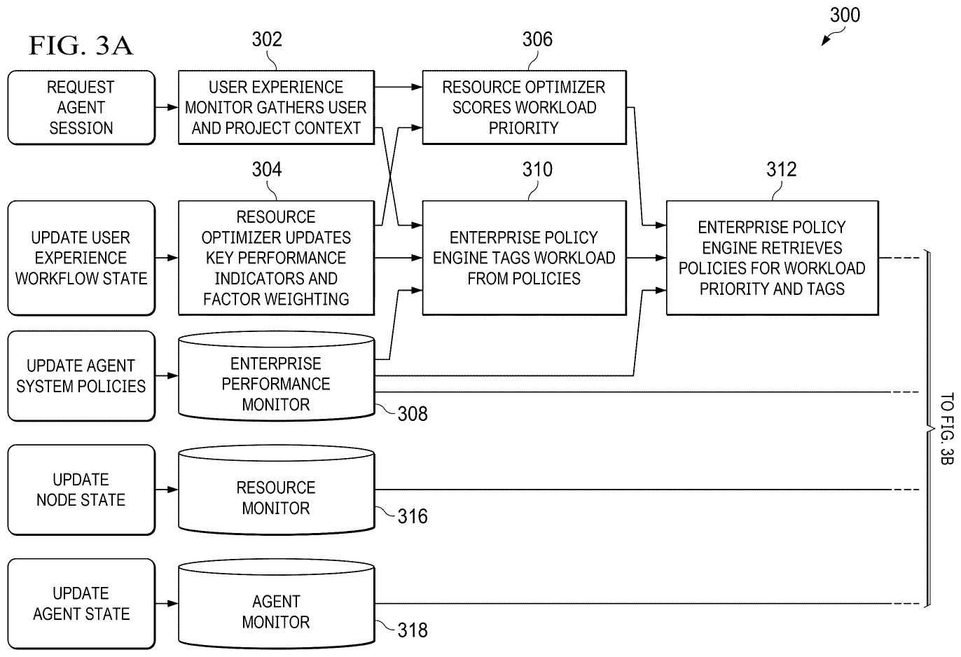

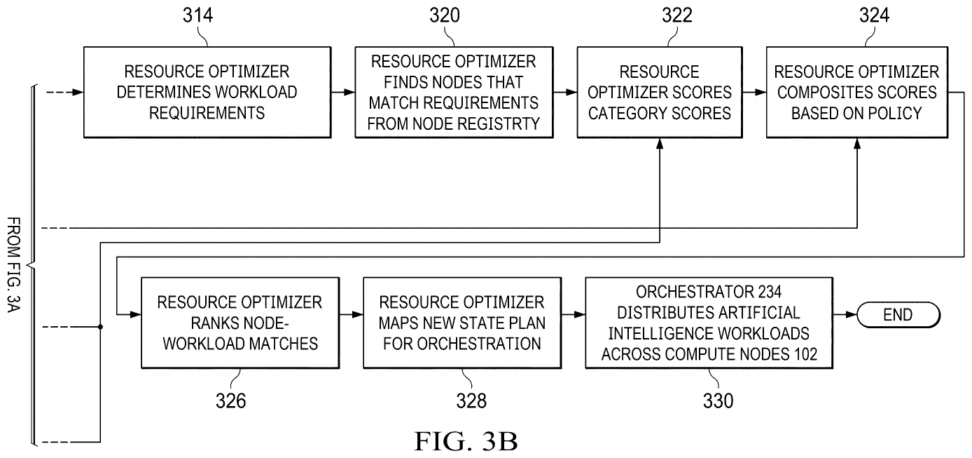

FIG. 3 illustrates a flow chart of an example method 300 for artificial intelligence distributed agent ecosystem resource optimization, in accordance with embodiments of the present disclosure. According to some embodiments, method 300 may begin at step 302. As noted above, teachings of the present disclosure may be implemented in a variety of configurations of system 100. As such, the preferred initialization point for method 300 and the order of the steps comprising method 300 may depend on the implementation chosen.

At step 302, responsive to a user request for an agent session, user experience workflow monitor 222 may gather context associated with a user requesting the session, including without limitation context associates with a project of the user.

At step 304, responsive to an update to user experience workflow state, resource optimizer 232 may update key performance indicators and weighting of factors.

At step 306, based on user context, key performance indicators, and weighing of factors, resource optimizer 232 may generate priority scores for the various artificial intelligence workloads to be executed.

At step 308, enterprise performance monitor 228 and enterprise policy engine 230 may receive an update to system policies for agents.

At step 310, enterprise policy engine 230 may, based on user context, key performance indicators, weighing of factors, and system policies for agents, generate policy tags for the various artificial intelligence workloads to be executed.

At step 312, enterprise policy engine 230 may retrieve policies for workload priorities and the policy tags.

At step 314, resource optimizer 232 may determine workload requirements for the requested sessions.

At step 316, resource monitor 224 may receive an update to a state of compute nodes 102.

At step 318, agent monitor 226 may receive an update to a state of artificial intelligence agents executing on compute nodes 102.

At step 320, resource optimizer 232 may identify compute nodes 102 that satisfy requirements for each session request.

At step 322, resource optimizer 232 may score category scores. These category scores may include, without limitation, such categories as user responsiveness impact, user quality impact, user concurrency impact, enterprise cost impact, and enterprise policy impact established for a prospective satisfying compute node and artificial intelligence workload pairing. These category scores may be computed in part by estimation of the various artificial intelligence workload performance on the satisfying compute nodes 102 identified in step 320.

At step 324, resource optimizer 232 may generate composite scores based on policies. These composite scores for each prospective satisfying compute node and artificial intelligence workload pair may be computed by combination of the category scores computed by the resource optimizer 232 in step 322, including by using factor weighting set in agent system policies to the enterprise performance engine 230.

At step 326, resource optimizer 232 may rank node-workload matches. This ranking may be established by methods such as using the established workload priority score to order drafting of a highest composite scoring compute node; ranking such that the highest aggregate composite score is achieved for all workloads and/or compute nodes; ranking such that tiers of workload priorities each achieve their highest aggregate composite score; or by computing other similar ranking computations.

At step 328, resource optimizer 232 may map a new state plan for orchestration based on the ranking of node-workload matches. This state plan may include agent and node state updates for each of the artificial intelligence workloads and compute nodes 102.

At step 330, based on the new state plan, orchestrator 234 may distribute artificial intelligence workloads across compute nodes 102 for execution of such workloads.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using a variety of configurations of system 100 and/or any other system operable to implement method 300. In certain embodiments, method 300 may be implemented partially or fully in software and/or firmware embodied in computer-readable media.

Optimization system for deploying heterogeneous workloads on heterogeneous capability distributed devices with experience, policy, cost, and quality of intelligence factors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to execute an agent system configured to:
collect and aggregate performance metrics from one or more artificial intelligence agents executing on one or more host systems; and
estimate parameters including resource requirements, performance targets, operating costs, and power usage associated with executing the one or more artificial intelligence agents on the one or more host systems.

2. The information handling system of claim 1, the processor further configured to, based on the parameters, process client requests to the agent system from one or more client programs executing on the one or more host systems.

3. The information handling system of claim 2, the processor further configured to collect client metrics regarding a workflow state for each of the one or more client programs, the client metrics including a user state, activity classification, and user work environment state.

4. The information handling system of claim 3, the processor further configured to generate priority scores for each of the client requests to establish the priority of the client requests based on the client metrics.

5. The information handling system of claim 4, the processor further configured to further modify the priority of the client requests by generating modified priority scores based on the parameters.

6. The information handling system of claim 5, the processor further configured to:
order the client requests in accordance with the modified priority scores; and
orchestrate the one or more host systems with the one or more agent computer programs to execute the client requests in accordance with the modified priority scores.

7. The information handling system of claim 1, wherein the one or more host systems comprises the information handling system.

8. A method comprising:
collecting and aggregating performance metrics from one or more artificial intelligence agents executing on one or more host systems; and
estimating parameters including resource requirements, performance targets, operating costs, and power usage associated with executing the one or more artificial intelligence agents on the one or more host systems.

9. The method of claim 8, the method further comprising, based on the parameters, processing client requests to the agent system from one or more client programs executing on the one or more host systems.

10. The method of claim 9, the method further comprising collecting client metrics regarding a workflow state for each of the one or more client programs, the client metrics including a user state, activity classification, and user work environment state.

11. The method of claim 10, the method further comprising generating priority scores for each of the client requests to establish the priority of the client requests based on the client metrics.

12. The method of claim 11, the method further comprising further modifying the priority of the client requests by generating modified priority scores based on the parameters.

13. The method of claim 12, the method further comprising:
ordering the client requests in accordance with the modified priority scores; and
orchestrating the one or more host systems with the one or more agent computer programs to execute the client requests in accordance with the modified priority scores.

14. An article of manufacture comprising:
a non-transitory computer-readable medium; and
computer-executable instructions carried on the computer-readable medium, the instructions readable by a processor, the instructions, when read and executed, for causing the processor to:
collect and aggregate performance metrics from one or more artificial intelligence agents executing on one or more host systems; and
estimate parameters including resource requirements, performance targets, operating costs, and power usage associated with executing the one or more artificial intelligence agents on the one or more host systems.

15. The article of claim 14, the instructions for further causing the processor to, based on the parameters, process client requests to the agent system from one or more client programs executing on the one or more host systems.

16. The article of claim 15, the instructions for further cause the processor to collect client metrics regarding a workflow state for each of the one or more client programs, the client metrics including a user state, activity classification, and user work environment state.

17. The article of claim 16, the instructions for further causing the processor to generate priority scores for each of the client requests to establish the priority of the client requests based on the client metrics.

18. The article of claim 17, the instructions for further causing the processor to further modify the priority of the client requests by generating modified priority scores based on the parameters.

19. The article of claim 18, the instructions for further causing the processor to:
order the client requests in accordance with the modified priority scores; and
orchestrate the one or more host systems with the one or more agent computer programs to execute the client requests in accordance with the modified priority scores.
